(19) United States
(12) Patent Application Publication
(10) Pub. No.: US 2026/0257426 A1
(43) Pub. Date: Sep. 3, 2026

(54) METHOD FOR DIMENSIONAL COMPENSATION OF A 3D OBJECT TO BE FORMED BY AN ADDITIVE MANUFACTURING APPARATUS

(71) Applicant: Stratasys Powder Production Ltd., Nottingham (GB)

(72) Inventors: Christopher PLEASS, London (GB); Alexander Roy MCARTHUR, London (GB); Robert MAY, London (GB); Torben LANGE, London (GB); Anders HARTMANN, London (GB)

(21) Appl. No.: 18/877,686

(22) PCT Filed: Mar. 6, 2024
(86) PCT No.: PCT/GB2024/050597

§ 371 Date: Dec. 20, 2024

(30) Foreign Application Priority Data
Mar. 7, 2023 (GB) 2303302.0

(51) Int. Cl. B29C 64/386; B33Y 50/00

(52) U.S. Cl. CPC B29C 64/386; B33Y 50/00

(57) ABSTRACT

A method for dimensional compensation of a 3D object to be formed by an apparatus for the layerwise manufacture of 3D objects. The method includes the steps of: receiving an object model to form a corresponding object in the apparatus; positioning the object model in a virtual build volume representing an actual build volume of the apparatus; determining a reference point for the object model, the reference point determining an object model location within the virtual build volume for the object model; selecting, from a scaling factor map comprising a plurality of predetermined scaling factors, a scaling factor corresponding to the object model location, each scaling factor corresponding to one or more of a plurality of locations within the virtual build volume; and applying the scaling factor to the object model.

### FIELD OF THE INVENTION

The present disclosure relates to a method for compensating against dimensional deviations in 3D objects, formed in an additive manufacturing apparatus, from their original object models. The method may be particularly beneficial in powder bed fusion apparatus in which unfused build material and formed objects undergo significant cooling. A controller to carry out the method is also disclosed.

### BACKGROUND

Powder bed fusion processes such as laser sintering and print and sinter processes have received significant attention in recent years as their throughputs become attractive for industrial manufacture. Build volumes over which the objects are formed are increasing in size, leading (amongst other things) to increasing differential thermal effects. Such differences affect part quality for objects manufactured at different locations within the build volume and/or objects of a size spanning a significant proportion of one or more dimensions of the build chamber. In particular, achieving reliable dimensional accuracy within required tolerances throughout an entire build volume becomes increasingly challenging. In certain applications it may be acceptable to apply an iterative process of forming a specific object at a specific location in the build volume, scanning the formed object, determining dimensional deviations, adjusting the object model, and forming the object again using the adjusted object model until the required accuracy is achieved. For a change in object location, for example due to different nesting, the process must be repeated. In cases in which the objects to be formed change on a monthly, weekly or even daily basis, for example when running bespoke build jobs for customers at service bureaus, this approach may be economically prohibitive. New solutions are therefore needed to achieve accurate parts without the need of iterative and time consuming calibration of each specific object model against machine and process conditions.

### SUMMARY

The invention is set out in the appended independent claims, while particular embodiments of the invention are set out in the appended dependent claims.

### BRIEF DESCRIPTION OF THE DRAWINGS

Reference is now directed to the drawings, in which:

FIG. 1 is a flow chart of the method according to the invention;

FIG. 2A is an example of a 2D scaling factor map superimposed on a horizontal cross section of the virtual build volume divided into nine zones;

FIG. 2B is a schematic 3D illustration of the virtual build volume divided into nine vertically extending zones to each of which a respective scaling factor is assigned;

FIG. 3A is a cross section side view through a virtual build volume with two object models; FIG. 3B is the virtual build volume of FIG. 8A after scaling each object model according to the method of FIG. 1;

FIG. 4 is a 2D map of scaling factors measured for each zone of a 5×6 array of zones;

FIG. 5 illustrates a 2D map after interpolation of values of the map of FIG. 4;

FIG. 6 is a variant of FIG. 2B illustrating a three dimensional scaling factor map;

FIG. 7A-7C is a schematic illustration of applying baseline compensation;

FIG. 8A is a schematic cross section side view of a virtual build volume divided by slices of varying separation;

FIG. 8B is a schematic cross section side view of a build volume comprising an object formed using the slices of FIG. 8A;

FIG. 9 is a curve schematically illustrating step wise adjustments in piston increment;

FIGS. 10A and 10B are two variants of the method of FIG. 1;

FIG. 11A is a schematic cross section side view of part of an additive manufacturing apparatus;

FIG. 11B illustrates detail of the powder bed of FIG. 11A built up layer by layer;

FIG. 12 is a curve schematically illustrating layer thickness increase;

FIG. 13A is a schematic cross section side view of a virtual build volume divided by slices of constant separation;

FIG. 13B is a schematic cross section side view of a build volume comprising an object formed using the slices of FIG. 13A; and

FIGS. 14A and 14B are block charts of two variants of a control system configured to carry out the method according to the invention.

In the drawings, like elements are indicated by like reference numerals throughout.

### DETAILED DESCRIPTION

In powder bed processes, the formed build volume comprises layerwise cross sections of one or more objects supported in the surrounding build material. The build volume experiences various physical effects that cause deviation from the intended dimensions of the objects. For example, the increasing weight of the build volume as more and more layers are added cause compaction of the lower regions. In addition, in thermal powder bed fusion processes such as laser sintering and “print and fuse”, the object is formed layerwise by thermally fusing or melting each cross section. The top layer may be maintained at around 10° C. to 20° C. below the melting point to avoid “curl” due to significant temperature differences. With typical melting points of PP, PA11 or PA12 ranging from 160° C. to 200° C., significant temperature differentials between the build volume and the exterior printer environment creates heat leakage paths and leads to differential cooling already during the build process. Upon cooling, the build volume generally shrinks, and adjustments for such global shrinkage are generally applied in such processes. Differential cooling adds a further degree of complexity. Generally, the centre of the build volume takes longer to cool compared to the outer regions of the build volume. The build volume shrinks faster towards the edges than at the centre due to heat escaping through the walls of the container holding the build volume, while the centre region is relatively insulated by the surrounding build material and remains hot for longer. As a result, the shrinkage of build material, both unfused or fused, within the build volume is location-dependent. This may to some degree be mitigated by applying heat to the side walls and/or the supporting platform, however applying excessive heat to mitigate differential shrinkage leads in turn to ageing the build material or even unintentional fusing. Thus, differential shrinkage within the build volume cannot be prevented fully. The effect is that objects made from identical object models end up being taller when manufactured near the edge of the build volume than objects made at the centre.

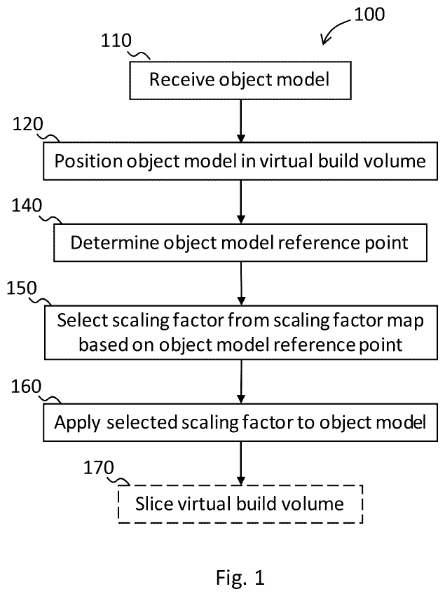

The inventors have recognised that in many cases a compromise may be reached by defining zonal compensation factors. The build volume is divided into a plurality of zones, for example vertically extending zones, and a common compensation factor is determined for each vertical zone. In this way, the dominant effect of vertical shrinkage effects due to differential cooling may be significantly improved. Each zone may comprise a group of a plurality of adjacent vertices or voxels. A method for applying shrinkage compensation according to the invention will now be described with reference to FIGS. 1 to 14.

FIG. 1 is a flow chart illustrating the method 100 according to the invention, the method comprising, at block 110, receiving one or more object models to form a corresponding object in an apparatus for the layerwise manufacture of objects;

At block 120, positioning the one or more object models in a virtual build volume representing an actual build volume of the apparatus in which the one or more objects are to be formed (herein also referred to as “3D printer);

At block 140, determining a reference point that represents the location for each object model within the virtual build volume. The reference point may for example be based on the volume and/or shape of the object model, and/or may be a coordinate within the virtual build volume defined by the centre of mass or of gravity of the object model, or a corner or centre of a virtual boundary, such as a box, enveloping the object model. A different determination of reference point may be based on the object model properties, for example on its size;

At block 150, selecting, from a predetermined scaling factor map comprising a plurality of predetermined scaling factors a respective scaling factor based on the reference point determined for the object model. Each scaling factor corresponds to one or more of a plurality of locations within the virtual build volume, such as a subvolume of the virtual build volume represented by a 3D zone. The zone may be larger than the one or more locations, and the size of the locations may correspond to a resolution of voxels in slice data for the actual build volume. The scaling factors may have been determined from test objects manufactured at a plurality of locations within the actual build volume, and wherein at least one of the test objects was formed within, but may not have filled, each zone; and

At block 160, applying the scaling factor to the object model. The scaling may for example be applied from the defined reference point, or from any other suitable predefined origin for the object model, for example from a centre point of a virtual bounding box that may be defined to encompass the object model.

Next, the virtual build volume comprising the scaled object model may be sliced at block 170 to convert it into layerwise raster data that may be used to control a laser or a printhead.

Some or each of the scaling factors on the scaling factor map may be predetermined from measurements of the vertical dimensions of test objects built in each zone in the real build volume against the intended object dimensions. Some of the scaling factors may be estimated, for example by interpolation between measured scaling factors, to complete the scaling factor map. The method described herein may obviate the need for iterative modification of a specific object model at a certain location within the build volume in a time consuming calibration process during which the object is repeatedly built and measured and the object model adjusted each time to correct for measured deviations from the intended one or more dimensions. Instead, scaling factors are obtained for certain locations or zones within the build volume that may be applied to any object model positioned within the build volume, independent of the object model itself.

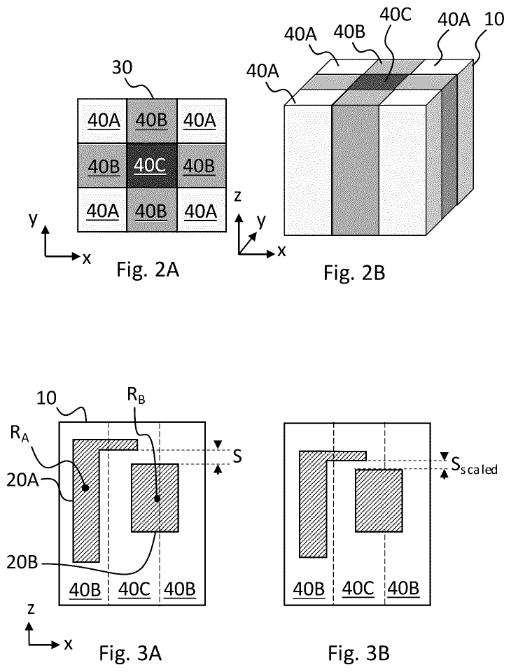

### Zones and Interpolated Scaling Factors of Maps: FIGS. 2-6

A two dimensional (2D) scaling factor map 30 for use at block 150 will now be illustrated with reference to FIG. 2A. FIG. 2A is a schematic illustration of a 2D scaling factor map superimposed on a horizontal cross sectional area of the virtual build volume. The cross sectional area is divided into nine cuboid zones 40, which, when viewed from above, are square in shape (or alternatively may be rectangular in shape). To each zone, a scaling factor is assigned, the value of which is indicated by the different shading, where a darker shade indicates a larger scaling factor than a lighter shade. The four corner zones 40A in this example map share a common, lowest, scaling factor, the central zone 40C has a unique and highest scaling factor, and zones 40B central along the edges of the map have an intermediate common scaling factor.

FIG. 2B is a three dimensional (3D) illustration of the virtual build volume 10 comprising the nine zones, each zone in this variant of the scaling factor map extending vertically through the entire height of the virtual build volume 10. The same scaling factor is assigned throughout the entire vertically extending zone. When an object model is positioned in the virtual build volume and its reference point, such as its centre of mass, is determined to fall within for example one of the four corner zones, the resulting object, built at or near a corner of the real build volume, may be compensated with the single scaling factor selected based on its reference point. Therefore, objects that may be formed too tall due to differential cooling (and thus shrinkage) effects may be corrected by scaling the object model according to the method disclosed herein. The predetermined scaling factor map is used as a look up map for each object positioned or nested in a virtual build volume and for which a reference point is determined. The scaling factor map may be a 2D scaling factor map that provides a predetermined scaling factor for each of a plurality of zones that, in the virtual build volume, extend upwards through the height of the virtual build volume. After applying the scaling factor, raster slices may be generated by dividing the virtual build volume into a stack of parallel planar slices stacked in the vertical direction, the vertical direction corresponding to the layering direction of the layers in the actual build volume; wherein each slice comprises voxels defining a cross section of the one or more object models, and wherein a plurality of voxels correspond to each zone or sub zone. Each slice comprises voxel data for use to control a printhead or laser to form each object cross section in a corresponding layer.

Each zone, with respect to corresponding slices or layers in the actual build volume, may preferably extend over a plurality of layers/slices along the vertical direction. Each slice or layer extends over a plurality of voxels, each voxel corresponding to for example a resolution defined in height by layer or slice thickness in combination with a width and length defined by the smallest feature that may be formed by the selective fusion component of the apparatus, such as a printhead. Preferably, each zone in the virtual build volume extends over a corresponding array of a plurality of voxels in the slice data. The scaling factor may have been measured over a subset of the plurality of voxels for each zone. In the virtual build volume, two or more vertical zones may correspond to substantially the same scaling factor of the map as illustrated in FIG. 2A by the four corner zones labelled 40A.

The step of determining the object model reference point and scaling factors at blocks 140 and 150 and the scaling step at block 160 are illustrated in FIGS. 3A and 3B. FIG. 3A is a schematic cross section side view of the virtual build volume 10 within which two object models 20A and 20B have been positioned, or nested. Three zones of the scaling factor map dividing the cross section are shown: the two zones 40B located at the edges of the virtual build volume, and the central zone 40C between the two edge zones. For each object model a reference point R is determined, in this case in form of the centre of mass indicated by a solid dot. The reference point RA determined for the first object model 20A falls within the left edge zone 40B. The reference point RB determined for the second object model 20B lies within the central zone 40C. Therefore, for the first object model 20A, the scaling factor corresponding to the edge zone 40B is selected at block 150, and for the second object model 20B, the scaling factor corresponding to the centre zone 40C will be selected. According to the shading of the zones in FIGS. 2A and 2B, the first object model will be scaled with a smaller scaling factor than the second object model.

Preferably, the scaling factors are provided as a reduction factor, i.e. they are a value from greater than zero up to 1. This means that compensation may be applied with relatively low complexity to ensure that collisions between object models do not occur, since none of the object models increase in the vertical direction, or in volume. Thus the first object model may be scaled with a smaller scaling factor than the second object model. In less preferred variants the scaling factors may be defined as being from 1 and above; in this case the object models increase in the vertical direction and this needs to be compensated with a global scaling correction and collision verifications. Scaling may be applied with respect to the determined object model reference point e.g. the centre of mass or gravity, or from any different suitable origin, for example from a centre of a corner of a rectilinear bounding box that may be defined to encompass the object model. The reference point may be user defined, e.g. the centre of one or more important dimensions for the object models. For example, the second object model, having its centre of mass at a point near the centre of the virtual build volume, may be scaled with a scaling factor less than but close to 1, for example 0.999, and the first object model may be scaled with a scaling factor less than that, for example 0.990. The actual values depend on the height of the build volume and the location of the object along it, for example. Scaling is applied to the vertical direction, and reduces both object models in the vertical direction.

FIG. 3B illustrates the first and second scaled object models within the virtual build volume 10 after step 160 is applied. As can be seen, even though the first object model 20A extends partially from the left hand edge zone zone 40B into the central zone 40C, its centre of mass lies within the edge zone 40B and the entire first object model is scaled by the single scaling factor assigned to the edge zone. Similarly, even though the second object model 20B extends partially into the right hand edge zone 40B, its centre of mass lies within the central zone 40C and the entire second object model is scaled by the single scaling factor assigned to the central zone. Thus, the entire object model may be scaled using the same scaling factor irrespective of whether some parts of the object model extend into one or more neighbouring zones. This scaling approach for example ensures that flat surfaces oriented parallel to the slice planes remain parallel after scaling. This means the surfaces are finished over a single layer and retain their intended surface quality, in contrast to methods in which multiple scaling factors are used per object model. Where more than one scaling factor is used to scale a horizontal, flat surface in an object model, a transition from one scaling factor to the next will result in the generation of visible layer lines in the flat surface of the built object.

FIGS. 3A and 3B illustrate two object models positioned within the virtual build volume 10 and scaled with individual scaling factors. Their initial closest separation S when positioned at block 120 may result in a scaled separation S_{scaled} at block 150 after scaling is applied, for example when the scaling factor is applied from the reference point, or from a centre point of the bounding box. Therefore, a minimum separation Sₘᵢₙ may be defined that is to be observed during positioning or automatic nesting the object model(s), such that object models may not be positioned closer to one another than the defined minimum spacing, i.e. S_{scaled}≥Sₘᵢₙ. This ensures that, after object models are scaled, the scaled separation S_{scaled} between objects is at least equal to or above the defined minimum spacing. This may ensure that object models do not collide or overlap where the separation becomes zero or less, or that objects do not fuse together due to thermal interactions as a result of being formed in too close proximity to one another. Similarly, a minimum boundary spacing may be defined and object models not positioned closer to a boundary of the virtual build volume than the defined minimum boundary spacing, such that after scaling, the scaled boundary spacings are equal to or above the defined minimum boundary spacing. The object models are positioned in the virtual build volume such that a distance between each said object model and a further said object model is equal to or greater than a predefined minimum object model separation; and/or a distance between each said object model and a boundary of the virtual build volume is equal to or greater than a predefined minimum boundary distance.

Alternatively, after scaling the object models at block 160, a verification routine may be carried out to flag if any separation or boundary spacing is below a predefined minimum, and repositioning is required. The routine may verify whether the distance between each scaled object model and a further scaled object model is equal to or greater than the predefined minimum object model separation; and/or the distance between each said object model and a boundary of the virtual build volume is equal to or greater than the predefined minimum boundary distance. If one or both of said distances are determined to be smaller than the corresponding predefined minimum object model separation and predefined minimum boundary distance, the method may comprise flagging that the one or more objects models are to be repositioned, for example by the controller carrying out the method displaying a notification on a user interface.

The examples of FIG. 2 and FIG. 3 illustrate 2D scaling factor maps with relatively few, large zones. Accuracy of formed object dimensions may be improved further by predetermining scaling factor maps with a larger number of relatively smaller zones.

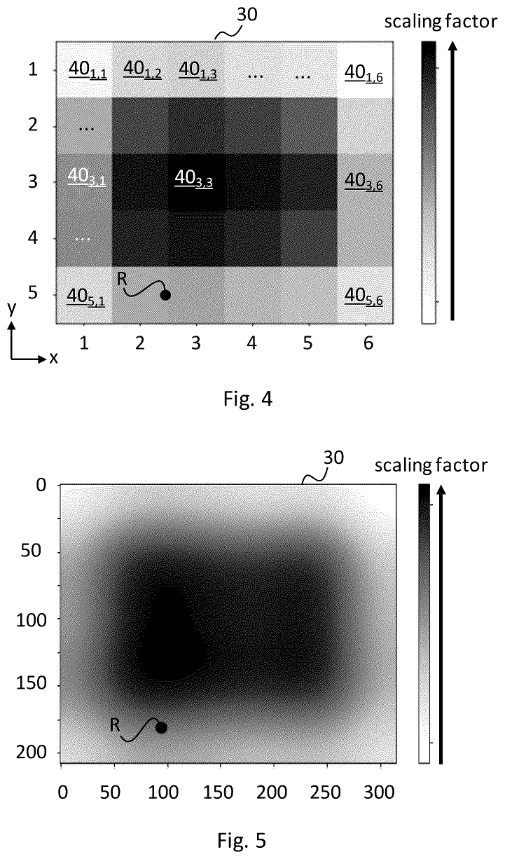

The predetermined scaling factors of the map may not be symmetric about a centre of the array of zones as shown in FIGS. 2A and 2B. The additive manufacturing apparatus, e.g. a “print and fuse” 3D printer, may produce variation along one or more horizontal axes. For example, some manufacturing or equipment processes may apply thermal energy by scanning a heat source unidirectionally, e.g. from left to right (along x). This may cause temperature variation along the x-axis within the build volume, leading to differential shrinkage that is offset from the centre of the top most surface (herein also called “build area”) of the build volume. Thermal conditions may vary across the build area along other directions, for example due to differences in insulation or ventilation from front to back or left to right of the build area. Such differences detected at the build area may persist through at least part of the underlying layers of the build volume and affect shrinkage conditions during cooling. The scaling factor map may thus represent a combination of thermal variations in the horizontal plane. This is illustrated in FIG. 4, which is a variant of FIG. 2A, and in which a horizontal cross section through the virtual build volume illustrates an asymmetric distribution of scaling factors across a 5×6 2D scaling factor map 30 superimposed onto 30 vertical zones of square cross section. As before, and as indicated by the side bar, darker shades represent larger scaling factors. The top left corner zones 40_{1,6} and 40_{1,1} of the map shown may have the lowest scaling factor, and which is lower than that determined for the bottom two corner zones 40_{5,1} and 40_{5,6}. This may compensate for a variation in shrinkage along the y-direction. The highest scaling factor corresponds to zone 40_{3,3}. Thus a scaling factor selected for a reference point R within a vertical zone at or near the centre of the virtual build volume 10 may be larger than the scaling factor selected for a reference point R within a vertical zone at or near a vertical boundary of the virtual build volume 10. Furthermore, the left hand side of the map appears to have overall larger scaling factors than the right hand side of the map, indicating a left to right variability in shrinkage of the build volume. The scaling factors indicated by the shading may vary from 1 (dark) to a value between zero and 1. In other words, the scaling factors between zero and 1 produce a reduction in the vertical direction of an object model, and object models with a reference point assigned to the lighter regions are reduced more than object models with a reference point assigned to the darker regions.

The granularity of scaling factors may be further enhanced by interpolation from one zone to the next. This is illustrated in FIG. 5, which is a scaling factor map over which the scaling factor array of discrete values of FIG. 4 has been interpolated. This means that from a plurality of zones 40 for each which a scaling factor was determined based on measurements, more accurate scaling factors may be calculated by interpolation, for example between the centres of each zone. This effectively divides the original zonal array into subzones, each subzone receiving a predetermined scaling factor. For the reference point R in FIG. 5, a slightly larger scaling factor may be selected in the interpolated map compared to the basic map of FIG. 4. In this way, the scaling may be more accurate and the formed object dimensions may correspond more closely to the intended object dimensions. The sub zones may correspond to more than one voxel each, and may be any suitable size, such as per square millimetre, or per several square millimetres, of the slice plane area. The zones may be divided into 2D pixels based on the resolution of for example the printhead of a print and sinter apparatus, such that each subzone is the size of a voxel. The scaling factor map may be pre-calculated and stored, or it may be stored in the basic form of only the measured scaling factors. Upon determination of the reference point, the coordinate within the map is determined and the interpolated scaling factor is determined from the adjacent measured scaling factors.

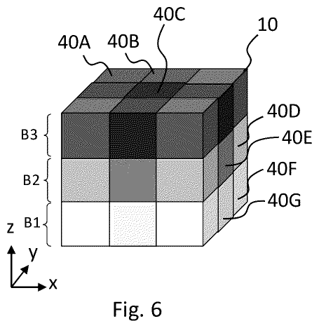

In variants of the method, the scaling factor map may be a 3D scaling factor map, to allow compensating for different shrinkage characteristics along the vertical direction of the build volume. For example, an object built in the upper region of the build volume may shrink differently to an object build in the lower or intermediate region of the build volume. Such shrinkage from the bottom to the top of the build volume may be non-linear due to different thermal boundary conditions of the virtual build volume. FIG. 6 is a variant of FIG. 2B in which the virtual build volume 10 is divided further into three horizontal bands B1, B2, B3 of zones, to form a virtual build volume of 3×3×3 zones. For each zone, a scaling factor is predetermined from measurements in the real build volume. As before, FIG. 6 illustrates by darker shading a larger scaling factor compared to lighter shading. In this example, the zones 40 are symmetric for each horizontal band about a central zone, as in FIG. 2B, although this is not essential. For each horizontal band Bn, a 2D scaling factor map may be defined, the combination of bands representing a 3D scaling factor map. In this way, object models may additionally be scaled based on the band into which their reference point is determined to fall. The virtual build volume may thus be divided into a plurality of vertical zones extending upwards through the virtual build volume, and wherein each vertical zone comprises a plurality of vertically stacked sub zones, each sub zone corresponding to a respective predetermined scaling factor, such that the scaling factor map is a 3D scaling factor map. A scaling factor selected for a reference point within a sub zone located at or near the top of the virtual build volume may be larger (e.g. closer to 1 from a value between zero and 1) than a scaling factor selected for a reference point within a sub zone located at or near the floor of the virtual build volume, so that an object model with a reference point within the sub zone 40C located at the top centre is reduced less in the vertical direction than an object model with a reference point within a sub zone below the centre top sub zone 40C. The scaling factor may thus vary from a value greater than zero up to 1. In this case the higher scaling factor causes less reduction in the vertical dimension of an object model compared to a lower scaling factor, and generally corresponds to an object location (as determined by the reference point) of lower object growth in the actual build volume, corresponding to locations at or towards the centre of a horizontal plane through the virtual build volume. The lower scaling factor causes a greater vertical reduction in dimension of the object model than a higher scaling factor and generally corresponds to an object location of larger object growth, from the location of lower object growth outwards towards the edges of the horizontal plane through the virtual build volume. The values for the zones may not be symmetric about the central zone as described for FIGS. 4 and 5 so as to take account of thermal variations in process and components of the apparatus used to form the objects.

Similarly, as described before with reference to FIGS. 4 and 5, the 3D scaling factor map may be expanded in resolution by interpolation to achieve a higher resolution of scaling factors. Each scaling factor may be predetermined for one or more coordinates (corresponding to for example a plurality of voxels) within each zone, or sub zone, and the zone or subzone may be larger in terms of corresponding voxels than the plurality of voxels over which the scaling factor was determined. For example, the scaling factor may be assigned to a central coordinate of the zone. If a determined reference point falls within the zone but outside the scaling factor coordinate, an interpolated scaling factor for that reference point coordinate may be determined based on the measured scaling factor within that zone or sub zone, and at least one further measured scaling factor (for example the nearest next scaling factor of an adjacent zone or sub zone) at their respective coordinates.

Optionally, an object model may be scaled by applying more than one scaling factor. For example, the object model may be divided by the zones over which it extends and each object model zone compensated by the respective scaling factor. Optionally, an object model may be scaled vertex by vertex before slicing voxel by voxel after slicing. By applying vertex by vertex compensation, it is not necessary to compromise on a single scaling factor, which may be beneficial for example where larger models extend over several zones for which the scaling factors are significantly different. Furthermore, object model collisions may be less likely when applying multiple scaling factors per object model. It may further be possible to change the scaling factor along the vertical direction within a single object model, for example by determining a plurality of reference points for the object model, wherein each reference point may be one of a plurality of vertices defining the surface of the object model, and selecting, from the scaling factor map, a plurality of scaling factors corresponding to each vertex location. These are approaches of increasing complexity, and for which it may not be possible to determine scaling factors with sufficient local accuracy to account precisely for changes in dimension while maintaining true object proportions. In addition, voxel by voxel or vertex by vertex compensation may generate layer lines on flat surfaces that were positioned parallel to the horizontal direction so as to achieve a smooth finish. Furthermore, differences in, or proximity to, thermal mass of objects inside the build volume may further affect dimensional changes and may render multiple scaling factor compensation per object model less accurate without further measures.

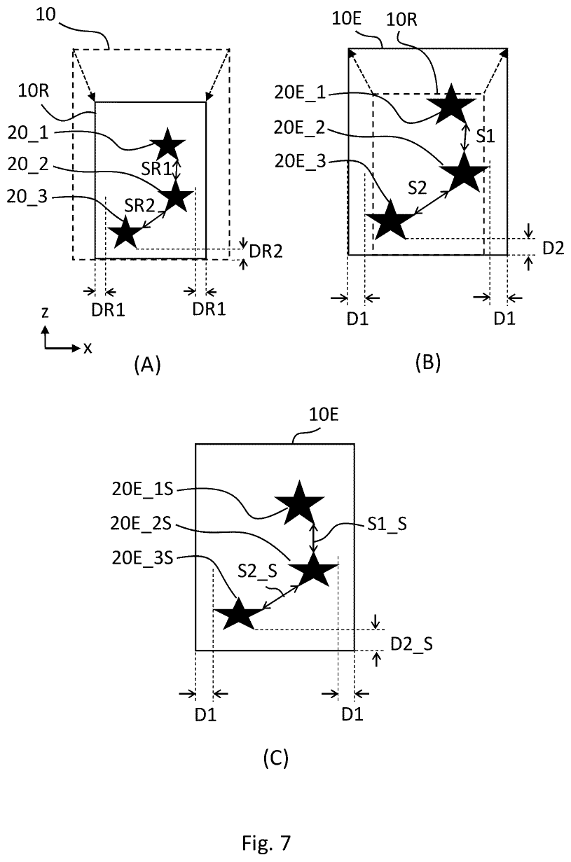

Reduced Virtual Build Volume; FIGS. 7a-7c

Scaling object models to compensate for cooling related shrinkage may further be improved at the data generation stage by applying an initial global scaling. Global scaling may account for the baseline shrinkage that applies throughout the build volume, for example a largest amount of shrinkage experienced by one or more of the test objects built at one or more locations. The virtual build volume may be normalised against this baseline shrinkage, by applying a baseline shrinkage factor to the virtual build volume. This is illustrated in FIGS. 7A to 7C, showing schematic cross sections through a virtual build volume 10 that has been scaled down according to the baseline shrinkage, to provide a reduced virtual build volume 10R. The reduced virtual build volume may be the size of the actual build volume after cooling. The reduced virtual build volume is used at block 120 so that object models are positioned into the reduced virtual build volume. FIG. 7A illustrates three object models 20_1, 20_2 and 20_3 positioned within the reduced virtual build volume 10R. The first and second object models 20_1, 20_2 are spaced apart by a separation SR1, and the second and third object models 20_2 and 20_3 are spaced apart by a separation SR2 that may be the same as the minimum separation distance. Furthermore, the object models are positioned such that they are spaced no more than a boundary separation distance DR1 from one of the side walls and no more than a floor separation distance DR2 from the floor of the reduced virtual build volume 10R. Next, as illustrated in FIG. 7B, the reduced virtual build volume 10R is expanded back to the size of the corresponding build volume in which the objects are to be formed. This may be the initial virtual build volume, i.e. by expanding the reduced virtual build volume by the inverse baseline shrinkage function leading to the expanded virtual build volume 10E. Since the expansion is a global expansion, the object models are expanded object models 20E_1, 20E_2, and 29E_3, and the separations and boundary distances are equally expanded separations S1, S2 and expanded boundary distances D1, D2 such that no overlap or collisions of expanded object models and objects to be formed can occur.

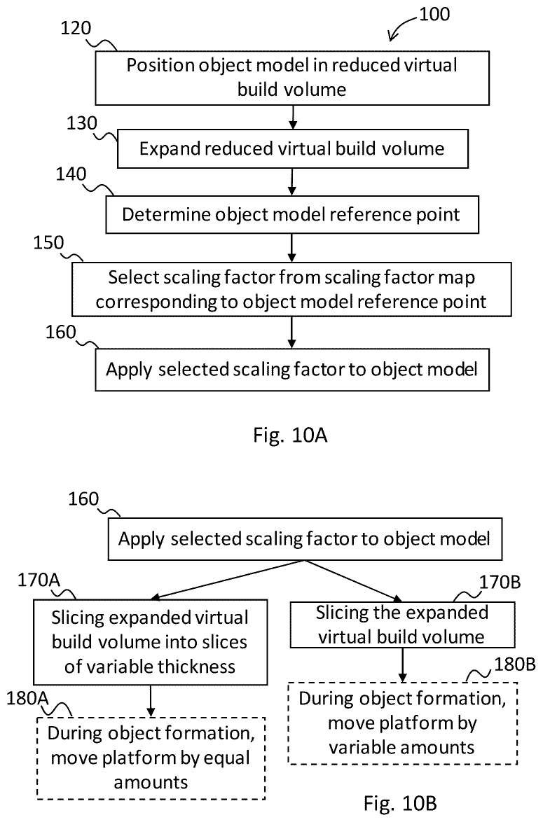

The reduction of the virtual build volume 10 may be achieved by reducing the initial virtual build volume in at least one of its dimensions, for example at least along the vertical direction, according to the fully shrunken build volume after cooling. In this way the one or more expanded object models 20E_n are larger than the one or more objects models 20_n, for example, at least along the vertical dimension so as to compensate for shrinkage. The map of predetermined scaling factors in this case is determined from test objects built using object models nested in the reduced build volume and slices prepared from the subsequently expanded virtual build volume, and fine tunes object dimensions in addition to the universally applied global baseline compensation. A global compensation step may provide improved accuracy in each object by for example allowing improved fine tuning of object dimensions when generating and applying the scaling factor map. The steps adding baseline expansion to the method of FIG. 1 are illustrated in FIG. 10A. The step of positioning the object models in the virtual build volume at block 120 now comprises positioning the object models in the reduced virtual build volume, wherein the reduced virtual build volume is provided to account for global or baseline shrinkage, such as representing the global reduction in the build volume after cooling.

At additional block 130, the reduced virtual build volume comprising the one or more object models is expanded to the dimensions of the actual build volume by an expansion transformation, wherein the expanded virtual build volume comprises the one or more object models expanded within the expanded virtual build volume. The object models are thus now expanded object models 20E of a volume greater than the original object model volume to account for a degree of global shrinkage. Furthermore at block 120, the one or more object models may have been positioned in the reduced virtual build volume such that a distance between each said object model and a further said object model is equal to or greater than a predefined minimum object model separation; and/or a distance between each said object model and a boundary of the virtual build volume is equal to or greater than a predefined minimum boundary distance. The predefined minimum object model separation may be adjusted to account for a “worst case scenario” of achieving the minimum separation upon applying the scaling factor, as is illustrated in FIGS. 3A and 3B. Each object model may thus be positioned in the reduced virtual build volume such that a separation distance between each object model is greater or equal to a predefined minimum separation distance, and a boundary distance between each object model and a boundary of the reduced virtual build volume is greater or equal to a predefined minimum boundary distance. Expanding the virtual build volume means expanding the virtual build volume in all directions along x, y, z and thus causes expansion of each of the plurality of object models, each separation distance and each boundary distance by the expansion transformation such that each expanded object model is larger than the original object model, each expanded separation distance is larger than the original separation distance, and each boundary separation distance is larger than the original boundary distance. By nesting in the reduced virtual build volume, a risk of object model collisions when applying geometrical compensation may be avoided.

Finally, illustrated in FIG. 7C, a scaling factor is applied to each object model corresponding to its determined reference point. The scaling factors are applied to the vertical dimension of each expanded object model, and as in FIG. 7C are preferably defined in terms of reduction factors, in a range of between 0 and up to and including 1. It can be seen that each scaled object model 20E_1S, 20E_2S and 20_3S is reduced along the vertical direction, wherein the outermost object models 20E_1S and 20_3S are more compressed (by a smaller scaling factor) than the object model 20E_2S in between them, with respect to the horizontal direction (along x).

Only the vertical dimension is changed, so that the lateral expanded boundary distances D1, D2 remain unchanged. Where the scaling factor is applied to each expanded object model from the centre of a virtual bounding box for example, the boundary spacing D2 between the objects and the floor of the expanded virtual build volume is either the same (scaling factor is 1) or increased to D2_S as shown.

At block 140, the reference point R for each expanded object model is determined. For example, the centre of gravity of each expanded object model 20E is determined. It will be appreciated that the centre of gravity of each expanded object model may be at a slightly different location to the centre of gravity of each object model determined according to FIG. 1. Based on the reference point, a scaling factor is selected at block 150 from a predetermined 2D or 3D scaling factor map, and applied to the expanded object model at block 160. The scaling factor that corresponds to the zone within which the determined reference point of the or each expanded object model falls, is selected from the (expanded) scaling factor map, and is applied to that corresponding expanded object model. The “expanded scaling factor map” may be the same as the initial scaling factor map without reducing and expanding the virtual build volume. As before, where the test object measured to determine a scaling factor for a respective zone spans only a portion of the zone, accuracy in the predetermined scaling factors may be improved further by interpolating between the measured scaling factors. Thus a more accurate scaling factor may be predetermined for a specific reference point within the zone but outside the actual measured test object location.

The baseline shrinkage transformation may therefore be determined based on a global shrinkage of the hot build volume to its cooled state. The transformation may be direction (dimension, axis) dependent, due to the build volume, and the object(s) within, shrinking differently along different directions in the build volume. The reducing transformation applied to provide the reduced virtual build volume 10R may be a single multiplier applied to equally each dimension x, y, z of the virtual build volume 10. Alternatively, to address more significant shrinkage along the vertical direction, the transformation may comprise an individual transformation component for each dimension of the initial virtual build volume 10. The transformation may comprise a respective scaling factor for at least two dimensions. For example, the scaling factor applied along the vertical dimension (along z) may be different to the scaling factor applied to the horizontal dimensions (along x and/or y). The baseline shrinkage compensation to provide the reduced virtual build volume may comprise a larger scaling factor for the vertical direction compared to one or both of the horizontal directions. In some cases, the baseline compensation to the horizontal directions may be the same, in other words it may be determined that the build volume cools and shrinks by the same proportion along x and y. Alternatively, they may be different, or one or both of x, y may not require a compensation. The reducing transformation and inverse, expanding transformation may be determined experimentally based on shrinkage of test objects within the cooled build volume, or based on a simulation taking into account build material expansivity and thermal process details, such as temperatures and cool down times.

The actual build volume in which objects are formed may be defined in terms of a printable volume surrounded by a buffer zone around the periphery in which no objects are formed. In variants of the method, the virtual build volume (or the expanded virtual build volume) may be defined to be the size of the printable volume. This obviates the need for defining a minimum boundary spacing so that during positioning of the object models, which may be done by automatic nesting algorithms that optimise the density and/or orientation of the object models, the object models can be placed right up to a boundary wall, while only the minimum object separations have to be observed.

In any of the variants of the method described herein, a virtual bounding box may be defined that envelops each object model, or expanded object model. The virtual bounding box may be a cuboid or any other suitable shape to contain the expanded object model. It may be optimised in shape and/or volume. For example it may be defined as the smallest possible cuboid to envelope the object model, or the expanded object model. The scaling factor is then applied with respect to an origin of the virtual object bounding box, for example from the geometrical centre of the virtual object bounding box. The object model or expanded object model is scaled down towards the geometric centre of the bounding box.

### Complementary Compensation for Variable Layer Thickness

The scaling factor maps described herein may not sufficiently compensate for certain dimensional inaccuracy effects, e.g. to fully adjust for variations in shrinkage along the vertical direction. Shrinkage variability along the vertical direction may further be due to compaction and/or shrinkage due to cooling of build material deeper down in the build volume. While applying a three dimensional scaling factor map, in which different scaling is applied to different vertical bands of zones, variability along the vertical direction may be addressed with improved accuracy. However due to the object models being scaled using a single scaling factor, differential shrinkage along the vertical direction cannot be addressed fully, especially for objects that extend over several bands or are built in a band of high variability near the top of the build volume.

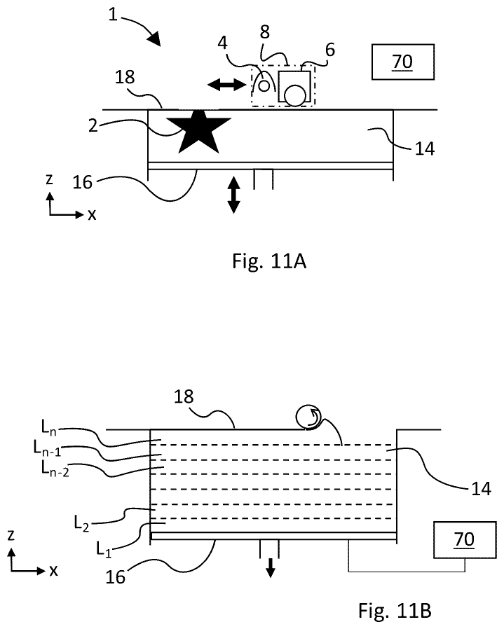

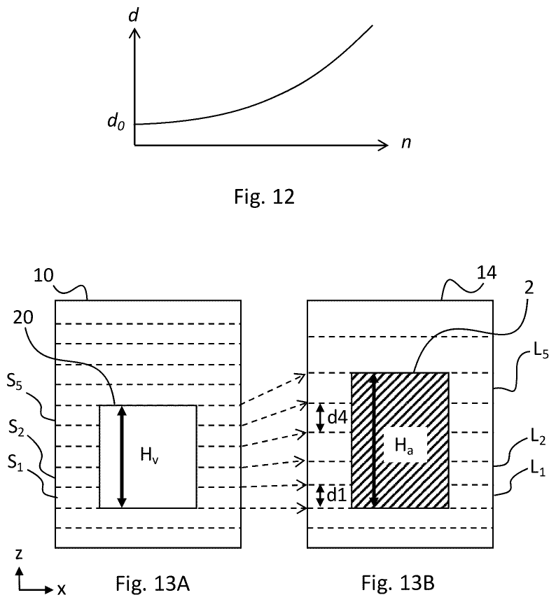

Additional approaches may be used to address dimensional variability of objects along the vertical direction. In a typical build process illustrated with reference to FIG. 11A, which illustrates a schematic cross section side view through a print and sinter apparatus 1, the build volume 14 is supported on a platform 16 that is moveable along the vertical direction along z. A controller 70 controls the distance by which the platform is lowered before each new layer is distributed across the top of the build volume by a distribution module 6 mounted to a carriage 8 moveable across the build volume. A cross section may be formed by selectively depositing infrared absorber by a printhead module (not shown) and heating the layer using an infrared lamp such as lamp 4. FIG. 11B illustrates in more detail the layering process of layers Ln. The platform is controlled to move a constant amount for each layer. The recess formed by lowering the platform allows the distribution module to fill the recess with unfused build material to form a new layer having a surface, or build area, 18. As the lower regions of the build volume cool and shrink, and/or compact due to weight bearing on it from the upper regions of the build volume, the recess becomes deeper than merely the distance by which the platform is lowered, and new layers become progressively thicker. FIG. 12 is a curve schematically illustrating the trend in layer thickness d with increasing number of layers n from an initial intended layer thickness do. Objects built over a multitude of layers deviating in thickness are formed with an inaccurate vertical dimension, for example taller, than intended. This is illustrated in FIGS. 13A and 13B, in which FIG. 13A illustrates a schematic cross section side view through the virtual build volume 10 comprising an object model 20 extending over a height Hv, wherein the virtual build volume 10 is divided into a sequence of vertically stacked horizontal slices Sn. FIG. 13B illustrates a corresponding schematic cross section side view through the build volume in which the object 2 is built and in which to form each layer, the platform is lowered by a constant distance. While the slices S₁, S₂, S₃ . . . are of constant thickness, the corresponding layers increase progressively in thickness d, with the thickness d1 of the first later of the object being smaller than the thickness d4 of the top most layer of the object. The resulting object height Hₐ is larger than the object model height Hv. Such variable layer thickness increase along the layering direction may be determined from test pieces built throughout the build volume and measured, and may increase progressively and non-linearly with the number of layers as shown in FIG. 12. Such non-linear thickness increase may be compensated for at the virtual build volume stage or the physical build stage as will now be described.

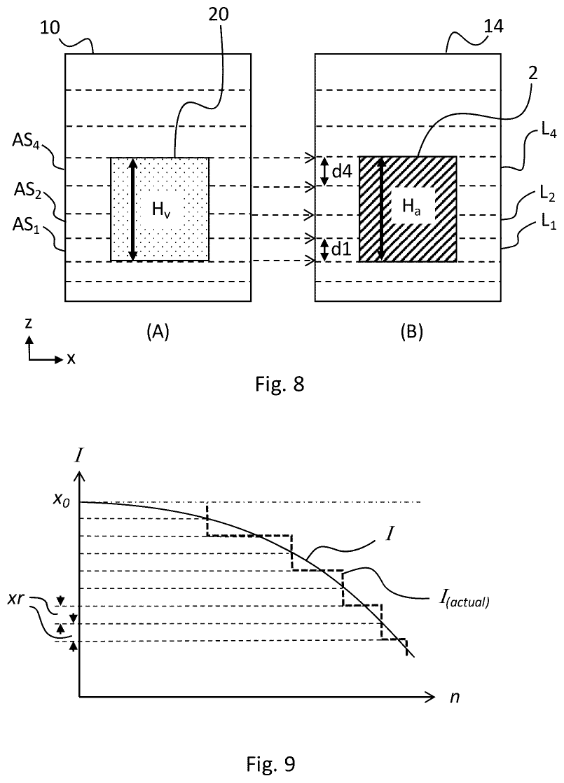

In a first variant, variable layer thickness compensation may be applied digitally, in the virtual build volume, along the layering direction (vertical direction) at the slicing stage. Compensation of an overall object dimension along the vertical may be achieved by applying slice planes that have a variable separation between them to arrive at slice data. The variable separation may be determined from the measured variation in vertical dimension from test object, corresponding to the schematically illustrated trend in layer thickness in FIG. 12. The slice planes may therefore be spaced apart by a progressively larger distance along the vertical direction from bottom to the top of the virtual build volume. This leads to the object model being defined over fewer slices compared to when applying the nominal slice separation. While the actual layer thickness progressively increase during the build process, the object is built over fewer layers to compensate against layer thickness increases. This is illustrated in FIGS. 8A and 8B, which are variants of FIGS. 11A and 11B, respectively. In FIG. 8A, the virtual build volume 10 is divided by a stack of adjusted slices ASₙ that are spaced apart by progressively larger distances, e.g. following the trend of FIG. 12 over a corresponding layer number and location. The slice planes may substantially track the built layers, or approximate the built layers, as is indicated in an ideal situation in the build volume 14 in FIG. 8B. While the actual layer thickness d of the layers Lₙ increases, as indicated by the top most layer of thickness d4 being larger than the lowest layer of thickness dl forming the object 2, the actual height Ha of the built object 2 is, or is closer to, the intended object model height Hᵥ.

Alternatively, the non-linear thickness increase of the layers may be compensated for at the physical build stage by applying a compensation to the movement of the platform that lowers the build volume for each layer. Based on a measured thickness increase, and/or an approximated thickness increase, similar to that shown in FIG. 12, a correction to the distance by which the platform supporting the build volume is lowered may be determined. FIG. 9 is a correction curve schematically illustrating an inverse of FIG. 12 in terms of platform movement. The nominal distance xo is the initial distance by which the platform is lowered for at least the lower layers of the build volume. As the build progresses, with increasing number n of layers, the distance x is progressively reduced to compensate against the deviation in vertical position of the build volume surface. The ideal distance I per layer Lₙ is shown by the bold curve of FIG. 12 and illustrates a non-linear decreasing trend. From the ideal curve I, an actual realisable curve I(actual) may be determined, for example based on the resolution xr of the stepper motor lowering the platform. As a result of the resolution in platform motion, a correction may be applied in a step wise manner by integer multiples of xr as shown by the dashed curve, oscillating about the ideal curve. The benefit of this variant over the digital variant of FIG. 8 is that the actual layer thickness is corrected and accuracy in fine features throughout the object may be improved. The variant according to FIG. 8 may result in measurable variation in layer thickness in the finished object, for example in variable layer lines of planar surface formed at an angle in the build volume, or by repeated fine features formed over the vertical extent of the object.

Complementary to the application of 3D scaling factor maps according to FIG. 1, dimensional accuracy along the vertical direction may be improved further by the application of variably spaced slice planes or variable platform movement, as illustrated in the flow chart of FIG. 10B, by either:
at block 170A, digitally modifying the position of the slice planes, by dividing the virtual build volume into groups of slices, wherein each group comprises one or more slices of the same slice thickness (or slice plane separation), and wherein the slice thickness is progressively increased from one group to the next, such that the slice thickness of an upper group is greater than the slice thickness of a lower group with respect to the vertical direction. The slice thickness may increase non-linearly in the layering direction. The slice thickness of the upper group may be larger than an intended layer thickness to be formed in the actual build volume. When providing the slices to the apparatus, and forming the one or more objects based on the generated slice data, the platform supporting the layers may be controlled to create a recess of substantially the same depth for each layer throughout the build process at block 180A; or
at block 170B, dividing the virtual build volume into a stack of evenly spaced parallel slices, providing the slices to the apparatus, and forming the one or more objects based on the generated slices, wherein the platform supporting the layers may be controlled to create a recess in the work surface over which build material is spread, whereby the recess is filled with particulate material to form a layer, and wherein controlling the platform at block 180B may comprise lowering the platform by a predefined distance x for each layer, wherein the predefined distance decreases over the number of layers generated to form the one or more objects, such that the formed layer thickness remains substantially the same. The predefined distance may decrease non-linearly over the number of layers generated. Additionally, or instead, the object models may be positioned in the reduced virtual build volume as described herein, the reduced virtual build volume expanded back to the original size, and the reference point determined for the expanded object models as described with reference to FIG. 7 and FIG. 10A.

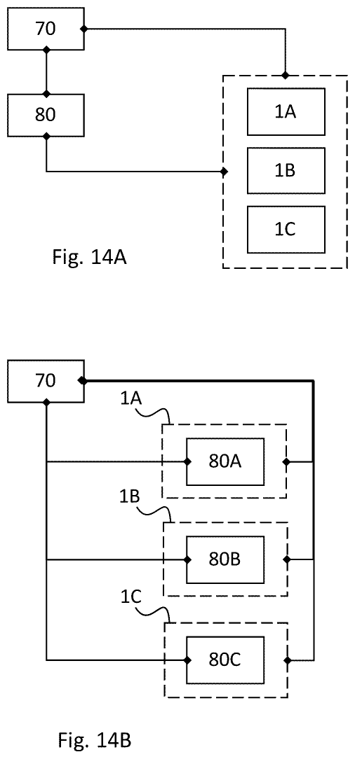

A scaling factor map may be predetermined per build material and for certain processing conditions (e.g. average build area temperature during processing, layer time, build material melting point, cooling rate after build is complete). Once a scaling factor map has been determined, it may be stored locally as an apparatus-specific map on the additive manufacturing apparatus on which the test objects were formed as illustrated in the block chart of FIG. 14B, or on a remote database as illustrated in the block chart of FIG. 14A, for example. The controller 70 as described herein may be a computer or microprocessor provided with a program that, when executed, causes the steps of the present method to be carried out. The controller may further comprise, or be configured to access, a data storage device storing the scaling factor map. A computer program may be provided comprising instructions which, when the program is executed by the controller, e.g. a computer, cause the controller or computer to carry out the method and its variants as described herein. A scaling factor map on a remote database may be identifiable for that specific additive manufacturing apparatus, or equally apply to and shared between a plurality of additive manufacturing apparatus. The data storage device 80 may be a remote data storage device accessible by the controller 70 via a network as shown in FIG. 14A, wherein the or each scaling factor map stored on the data storage device 80 is identifiable as corresponding to one or more of a plurality of additive manufacturing apparatuses 1A, 1B, 1C. Each of the plurality of apparatuses may have contributed to forming the test objects measured to determine the scaling factor map, and/or may be configured to process the specific build material at substantially the same process conditions used to form the test objects. The controller may be configured to access a respective scaling factor map by identifying it as corresponding to the apparatus for which the slice data is to be generated. The scaling factor map may be universally applicable to a fleet of additive manufacturing apparatus, for example configured to process substantially the same material and under substantially the same thermal processing conditions. Optionally, accuracy may be further improved by fine tuning a base compensation map printer by printer to achieve individually tuned scaling factor maps. As show in the block diagram of FIG. 14B, the data storage device may comprise a plurality of respective data storage devices 80A, 80B, 80C, each located within one of the plurality of additive manufacturing apparatuses 1A, 1B, 1C, and accessible by the controller 70 via a network to provide slice data for one of said additive manufacturing apparatus. The controller may be configured to determine an interpolated scaling factor from the determined scaling factor based on the determined reference point and one or more further scaling factors from respective adjacent zones. Optionally, the reference point is selectable from one of the centre of mass, the shape, the volume, and an origin of a virtual envelope of the object model or the expanded object model, and wherein each selectable reference point is stored on or accessible by the controller, wherein the controller is further configured to select one of the defined reference points for each respective object model or expanded object model based on one of the model shape and/or volume or special features, or based on user input.

1. A method of generating slice data for an apparatus for the layerwise manufacture of 3D objects from build material, the method comprising:
receiving one or more object models to form a corresponding object in an apparatus for the layerwise manufacture of objects;
positioning each object model in a virtual build volume representing an actual build volume of the apparatus in which each object is to be formed;
determining a reference point for each object model, each reference point determining an object model location within the virtual build volume for the corresponding object model;
selecting, from a scaling factor map comprising a plurality of predetermined scaling factors, a scaling factor corresponding to each object model location, each predetermined scaling factor corresponding to one or more of a plurality of locations within the virtual build volume; and
applying each selected scaling factor to the corresponding object model; and
after applying the scaling factor, generating slice data by dividing the virtual build volume into a stack of parallel planar slices stacked in the vertical direction, the vertical direction corresponding to the layering direction of the layers in the actual build volume, wherein each slice defines a cross section of the one or more object models.

2. The method of claim 1, comprising determining the reference point for each object model based on the volume and/or shape of the object model.

3. The method of claim 2, wherein the reference point is the centre of gravity or the centre of mass of the object model.

4. The method of claim 1, wherein the scaling factor map is a 2D map defining a predetermined scaling factor for each of a plurality of vertical zones extending upwards through the virtual build volume.

5. The method of claim 4, wherein the two or more vertical zones correspond to substantially the same scaling factor.

6. The method of claim 4, wherein the scaling factor selected for a reference point within a vertical zone at or near the centre of the virtual build volume is larger than the scaling factor selected for a reference point within a vertical zone at or near a vertical boundary of the virtual build volume.

7. The method of claim 1, wherein the virtual build volume comprises a plurality of vertical zones extending upwards through the virtual build volume, and wherein each vertical zone comprises a plurality of vertically stacked sub zones, each sub zone corresponding to a respective predetermined scaling factor, such that the scaling factor map is a 3D scaling factor map; and wherein the scaling factor selected for a reference point within a sub zone located at or near the top of the virtual build volume is larger than a scaling factor selected for a reference point within a sub zone located at or near the floor of the virtual build volume.

8. (canceled)

9. The method of claim 1, wherein the virtual build volume is a reduced virtual build volume smaller in at least one dimension than the actual build volume; wherein
positioning the one or more object models comprises positioning the one or more object models in the reduced virtual build volume;
expanding comprises expanding the reduced virtual build volume comprising the one or more object models to the dimensions of the actual build volume by an expansion transformation, wherein the expanded virtual build volume comprises the one or more object models expanded within the expanded virtual build volume;
determining comprises determining the reference point for each expanded object model; and
selecting comprises selecting from the scaling factor map a scaling factor corresponding to the determined reference point of each expanded object model;
wherein each selected scaling factor is applied to the corresponding expanded object model.

10. The method of claim 1, wherein each scaling factor is predetermined for one or more coordinates within each zone, or sub zone, wherein, for a reference point falling outside the one or more coordinates of a zone, an interpolated scaling factor is determined based on the scaling factor of that zone or sub zone and at least one further scaling factor of an adjacent zone or sub zone.

11. (canceled)

12. The method of claim 1, wherein generating the slices comprises dividing the virtual build volume into groups of slices, wherein each group comprises one or more slices of the same slice thickness, and wherein the slice thickness is progressively increased from one group to the next, such that the slice thickness of an upper group is greater than the slice thickness of a lower group with respect to the vertical direction, wherein the slice thickness of the upper group is larger than a target layer thickness to be formed in the actual build volume, and wherein the target layer thickness is constant for all layers.

13. The method of claim 12, wherein the slice thickness is increased non-linearly in the layering direction.

14. (canceled)

15. The method of claim 111, wherein the slices are evenly spaced, the method further comprising, forming the one or more objects based on the generated slice data, and controlling a platform supporting the layers to create a recess in a work surface over which build material is spread, whereby the recess is filled with particulate material to form a layer, wherein controlling the platform comprises lowering the platform by a predefined distance for each layer, wherein the predefined distance decreases over the number of layers generated to form the one or more objects, such that the formed layer thickness substantially equals a target layer thickness to be formed in the actual build volume, and wherein the target layer thickness is constant for all layers.

16. The method of claim 15, wherein the predefined distance decreases non-linearly over the number of layers generated.

17. The method of claim 1, comprising positioning each of said object models such that a distance between each said object model and a further said object model is equal to or greater than a predefined minimum object model separation; and/or a distance between each said object model and a boundary of the virtual build volume is equal to or greater than a predefined minimum boundary distance.

18. The method of claim 17, comprising, after scaling the object model, verifying that the distance between each scaled object model and a further scaled object model is equal to or greater than the predefined minimum object model separation; and/or the distance between each said object model and a boundary of the virtual build volume is equal to or greater than the predefined minimum boundary distance; and if one or both of said distances are smaller than the corresponding predefined minimum object model separation and predefined minimum boundary distance, generating an alert that the one or more objects models are to be repositioned.

19. The method of claim 9, wherein positioning comprises:
positioning each object model in the reduced virtual build volume such that a separation distance between each object model greater or equal to a predefined minimum separation distance, and, optionally, such that a boundary distance between each object model and a boundary of the reduced virtual build volume is greater or equal to a predefined minimum boundary distance; and
expanding the virtual build volume comprises expanding each of the plurality of object models, each separation distance and each boundary distance by the expansion transformation such that each expanded object model is larger than the corresponding object model, each expanded separation distance is larger than the corresponding separation distance, and, optionally, each boundary separation distance is larger than the corresponding boundary distance.

20. The method of claim 9, comprising applying each selected scaling factor to the corresponding expanded object model, from a predefined origin of the object model or the expanded object model.

21. The method of claim 20, wherein the predefined origin is the reference point.

22. The method of claim 20, comprising defining a virtual bounding box enveloping each expanded object model, and applying the scaling factor from an origin of the virtual bounding box comprising the or the expanded object model.

23. (canceled)

24. The method of claim 1, wherein the scaling factor is a value from greater than zero to 1, and wherein the scaling factor increases from a side of the virtual build volume to the centre of the virtual build volume.

25. (canceled)

26. (canceled)

27. (canceled)

28. (canceled)

29. (canceled)
